(19) United States
(12) Patent Application Publication
(10) Pub. No.: US 2021/0071460 A1
(43) Pub. Date: Mar. 11, 2021

(54) LOUVRE-CONTROL DEVICE, IN PARTICULAR FOR A MOTOR VEHICLE, AND FRAME COMPRISING SUCH A DEVICE

(71) Applicant: Valeo Systemes Thermiques, Le Mesnil-Saint-Denis (FR)

(72) Inventors: Karim Arab, Le Mesnil Saint-Denis (FR); Sylvain Gerber, Le Mesnil Saint-Denis (FR); Enzo Mitidieri, Le Mesnil Saint-Denis (FR); Laura Marion, Le Mesnil Saint Denis (FR); Frédéric Vacca, Le Mesnil Saint-Denis (FR); Victor-Manuel Minero, Le Mesnil Saint Denis (FR)

(73) Assignee: Valeo Systemes Thermiques, Le Mesnil-Saint-Denis (FR)

(21) Appl. No.: 16/772,405

(22) PCT Filed: Jan. 15, 2019
(86) PCT No.: PCT/FR2019/050079

§ 371 Date: Jun. 12, 2020

(30) Foreign Application Priority Data
Jan. 19, 2018 (FR) 1850422
Jan. 19, 2018 (FR) 1850423
Jan. 19, 2018 (FR) 1850424

(51) Int. Cl. E05F 15/40; B60K 11/08; F03G 7/06

(52) U.S. Cl. CPC E05F 15/40; F01P 7/10; F03G 7/065; B60K 11/085

(57) ABSTRACT

The invention relates to a control device (1), in particular for a motor vehicle, for controlling at least one flap configured to be moved between an open position and a closed position by an actuator, said device (1) comprising at least one member (8) made of shape memory material configured to be supplied with electric power so as to deform between a first state and a second state in order to disconnect said at least one flap from the actuator if the actuator fails.

According to the invention, said device (1) has a track holder (10) that is mounted in said device (1) in a rotationally retained manner and has at least two conductive tracks (101) for supplying said at least one member (8) made of shape memory material with electric power, and said at least one member (8) made of shape memory material has at least two contactor elements (87) configured to each be arranged in electrical contact with an associated conductive track (101) at least when said at least one member (8) made of shape memory material is in the first state.

The invention also relates to a corresponding frame.

The invention relates to a flap control device in particular for a motor vehicle comprising at least one flap and an actuator that moves said at least one flap between a closed position and an open position. The invention also relates to a frame comprising such a device.

The front ends of motor vehicles are generally made up of an air intake or two air intakes, referred to as the top route and the bottom route, that are separated by a bumper beam. Generally placed behind this bumper beam is a heat exchange device of the motor vehicle, comprising one or more heat exchangers, for example the ones used for air conditioning the passenger compartment, through which a flow of air introduced through the air intake(s) at the front of the vehicle is intended to pass.

At least one flap panel is also generally mounted in the air intakes of the vehicle. The flaps are formed for example by slats mounted in a pivotable manner on the panel, for example in a substantially transverse manner. The inclination of the flaps can be steered by an actuator between a closed position, for example vertical, blocking the passage of the air, and several intermediate positions as far as an open position, for example horizontal, in which a maximum flow of air can flow. When the flap panel is closed, the vehicle has a better air penetration coefficient, making it possible to reduce fuel consumption and the emission of CO2.

According to a known solution, the flaps can be driven via a driver such as a control lever coupled to the actuator.

The steered flaps are therefore arranged in front of the heat exchange device and are used to reduce the drag coefficient and to improve the performance of the heat exchange device.

However, if the actuator fails, the flaps can find themselves stuck in the closed position, thereby blocking the passage of air toward the heat exchange device and causing the engine to overheat.

It has been proposed to couple the actuator and the flap control lever by way of a mobile core forming a transmission element between the control lever and the actuator. If the actuator fails, this mobile core is moved toward a release position so as to disconnect the actuator. To this end, a moving means such as a solenoid makes it possible to move the mobile core. However, such a system can prove to be bulky.

According to another solution, a member made of shape memory material, such as a wire made of shape memory material, which is able to change state, is arranged so as to disconnect the flaps from the actuator when it changes state. In particular, the wire made of shape memory material is designed to act on the transmission element for transmitting the movement from the actuator to the flap control lever, if the actuator fails, such that it is disconnected from the control lever. The flaps can adopt an open position freeing up the air intake, independently of the actuator. The air can thus exchange with the fluids flowing through the heat exchangers of the motor vehicle, thereby avoiding overheating of the engine and emergency stopping of the vehicle.

In particular, the transmission element is designed to transmit a rotational movement from the actuator to the control lever steering the flaps. The wire made of shape memory material is also mounted in a rotatable manner. Such a member made of shape memory material can be supplied with electric power in order to change state. In this case, power supply cables make it possible to electrically connect the wire made of shape memory material to a power source external to the control device. However, during normal operation, the various elements of the control device, namely the wire made of shape memory material, are driven in rotation by the actuator. This results in the power cables of the wire made of shape memory material also turning at the same time as the control lever, the transmission element and the wire made of shape memory material, during all the flap closing and opening cycles. This load exerted on the power cables causes a risk of premature wear to these power cables.

The objective of the present invention is to at least partially solve the drawbacks of the prior art by proposing a compact alternative that makes it possible to disconnect the flaps from the actuator if the actuator fails, while making the supply of electric power to the member made of shape memory material more reliable.

To this end, a subject of the invention is a control device, in particular for a motor vehicle, for controlling at least one flap configured to be moved between an open position and a closed position by an actuator, said device comprising at least one member made of shape memory material configured to be supplied with electric power so as to deform between a first state and a second state in order to disconnect said at least one flap from the actuator if the actuator fails.

According to the invention, said device has a track holder that is mounted for example in said device in a rotationally retained manner and has at least two conductive tracks for supplying said at least one member made of shape memory material with electric power, and said at least one member made of shape memory material has at least two contactor elements configured to each be arranged in electrical contact with an associated conductive track at least when said at least one member made of shape memory material is in the first state.

Such a track holder remains rotationally retained during the various flap opening and closing cycles. The electric power supply is ensured by the contact between the contactor elements of said at least one member made of shape memory material and the conductive tracks. Therefore, there are no longer any power cables leading to the member made of shape memory material that risk being driven in rotation during the various flap opening and closing cycles.

According to one aspect of the invention, said device has said at least one flap configured to be moved between an open position and a closed position by the actuator.

According to one aspect of the invention, said at least one member made of shape memory material is mounted so as to be rotatable about a driving axis with respect to the track holder. In this way, a turning contactor for supplying power to the member made of shape memory material is realized.

In particular, the contactor elements are able to move with respect to the track holder.

Even if the other elements of the control device, in particular the member made of shape memory material, are driven in rotation by the actuator, with respect to the track holder, which remains rotationally retained, contact is ensured between the contactor elements of the member made of shape memory material and the conductive tracks, making it possible to supply power to the member made of shape memory material when it needs to change state.

Said device can also have one or more of the following features, taken separately or in combination:
said at least one member made of shape memory material is configured to pass from a compressed rest state to an expanded state when it is supplied with power;
said at least two conductive tracks of said holder are separated by a nonconductive track;
said contactor elements are configured such that, at the end of travel of said at least one member made of shape memory material that deforms between the first state and the second state when it is supplied with electric power, at least one of said contactor elements is moved so as to come into mechanical contact with the nonconductive track;
the holder has an annular overall shape that is centered on the driving axis and has a predefined radial size;
said at least two contactor elements are designed with a radial size smaller than or around the same as the radial size of the track holder;
the contactor elements are realized by sliding contacts;
the contactor elements are each arranged in electrical contact with an associated conductive track, regardless of the state of said at least one member made of shape memory material;
the contactor elements are each arranged in electrical contact with an associated conductive track, regardless of the angular position of said at least one member made of shape memory material with respect to the track holder;
the contactor elements are at least partially flexible;
the conductive tracks are on a face of the track holder that is arranged facing said at least one member made of shape memory material;
the track holder has at least one electrical connector for supplying power to the conductive tracks, said electrical connector being arranged on the opposite side from the conductive tracks;
said device comprises a driveshaft configured to be arranged so as to transmit a movement from the actuator to said at least one flap;
the driveshaft has a cavity for receiving said at least one member made of shape memory material;
said device comprises a driver configured to be coupled to said at least one flap;
said device comprises a transmission element that is rotationally coupled to the driveshaft and mounted so as to be movable between an engaged position, in which it is rotationally coupled to the driver, and a disengaged position, in which it is decoupled from the driver;
said at least one member made of shape memory material is configured to urge the transmission element toward the disengaged position if the actuator fails;
the driveshaft is configured to be driven in rotation about a driving axis by the actuator;
the transmission element is axially movable between the engaged and disengaged position;
the driver has a housing in which the driveshaft and the transmission element are at least partially arranged;
the track holder is fitted to the driver so as to close the housing;
the track holder is formed by a cover of the driver;
the transmission element is arranged around an end portion of the driveshaft having the cavity for receiving said at least one member made of shape memory material;
the transmission element has a main body arranged around the end portion of the driveshaft and an end wall arranged facing the end portion of the driveshaft;
the end wall is formed on a closure cap fitted to the main body;
the end wall of the transmission element has at least two openings for the contactor elements of said at least one member made of shape memory material to pass through;
said device has at least one seal arranged at the interface between the driver and the track holder;
said device has at least one seal arranged at the interface between the driver and the driveshaft;
said at least one member made of shape memory material comprises at least one spring;
said device has an elastic return element arranged so as to urge the transmission element toward the engaged position, such that said at least one member made of shape memory material is configured to urge the transmission element toward the disengaged position counter to the load applied by the elastic return element.

A further objective of the present invention is to at least partially solve the drawbacks of the prior art by proposing a compact alternative that makes it possible to disconnect the flaps from the actuator if the actuator fails and to move the control lever into an open position of the flaps if it is released.

To this end, a subject of the invention is a control device, in particular for a motor vehicle, for controlling at least one flap configured to be moved between an open position and a closed position, said device comprising:
a driver configured to be coupled to said at least one flap and configured to be driven by an actuator so as to move said at least one flap and to be disconnected from the actuator if the actuator fails,
a driveshaft configured to be driven by the actuator, and
a transmission element mounted so as to be movable between:
   an engaged position, in which it couples the driveshaft to the driver, and
   a disengaged position, it which it disconnects the driver from the driveshaft.

According to the invention, said device has at least one elastic return means arranged so as to act on the driver in order to move it, when it is disconnected from the driveshaft, into a predefined position, wherein the driver is configured to keep said at least one flap in the open position when the driver is coupled to said at least one flap.

The return member is incorporated into the control device. It is not an external element. In addition, this return member is arranged as close as possible to the driver in order to act directly on the latter, and not for example on the flaps.

This ensures, in a single compact mechanism, not only the engagement and disengagement for coupling the driver to the actuator or disconnecting it therefrom, but also the opening of the flaps if the actuator fails without the latter acting, when the return member returns the driver, after it has been disconnected from the driveshaft intended to be coupled to the actuator, into the predefined position allowing the opening of the flaps.

According to one aspect of the invention, said device has said at least one flap configured to be moved between an open position and a closed position.

According to another aspect of the invention, the transmission element is rotationally coupled to the driveshaft in the engaged and disengaged positions. In the engaged position, it is rotationally coupled to the driver so as to be able to transmit a movement from the driveshaft to the driver. In the disengaged position, it is decoupled from the driver so as to disconnect the driver from the driveshaft.

Said device can also have one or more of the following features, taken separately or in combination:
the transmission element is separate from the driver;
said at least one elastic return member is realized in the form of a return spring;
said at least one elastic return member is a torsion spring;
said at least one elastic return member is fixed on one side to the driver and on the other side to a fixed element of said device;
said device has a base arranged in a fixed manner in said device;
said at least one elastic return member is fixed on one side to the driver and on the other side to the base;
the base has an internal space for receiving a portion of complementary shape of the driver;
said at least one elastic return member is arranged between the driver and an internal wall of the base;
the portion of the driver that is received in the base has a tubular overall shape;
said at least one elastic return member is arranged around the portion of the driver that is received in the base;
the driver has an element for holding one of the ends of the return spring;
the base has another element for holding the other end of the return spring;
the base has a slot for holding one of the ends of the return spring;
the driveshaft is configured to be driven in rotation about a driving axis by the actuator;
the transmission element is axially movable between the engaged and disengaged position;
the driver has a housing in which the driveshaft and the transmission element are at least partially arranged;
said device has at least one member made of shape memory material that is configured to deform between a first state and a second state and is arranged so as to act on the transmission element in order to disconnect it from the driver if the actuator fails;
the member made of shape memory material has at least one spring;
the member made of shape memory material is configured to urge the transmission element toward the disengaged position if the actuator fails;
the driveshaft has a cavity for receiving said at least one member made of shape memory material;
   said device has another elastic return member arranged so as to urge the transmission element toward the engaged position, such that the member made of shape memory material is configured to urge the transmission element toward the disengaged position counter to the load applied by the elastic return member.

A further objective of the present invention is to at least partially solve the drawbacks of the prior art by proposing a driveshaft alternative, making it possible to obtain a compact flap control device for disconnecting the flaps from the actuator if the actuator fails, and in which the cooperation with one or more other elements of such a flap control device such as the control lever is improved.

A further subject of the invention is a driveshaft for a control device, in particular for a motor vehicle, for controlling at least one flap configured to be moved between an open position and a closed position by an actuator, said device having a driver configured to be coupled to said at least one flap, the driveshaft being configured to transmit a torque from the actuator to the driver.

According to the invention, the driveshaft has at least one element for preventing the driver from moving in translation.

Such a driveshaft, when it is arranged in a corresponding flap control device, makes it possible, it addition to its function of transmitting torque from an actuator to the driver intended to move the flaps, to axially hold this driver.

The driveshaft can also have one or more of the following features, taken separately or in combination:
the driver is prevented from moving in translation by snap-fastening;
said at least one movement preventing element has a peripheral groove configured to cooperate with at least one complementary movement preventing element carried by the driver;
the driveshaft has a portion configured to be received in the driver and to cooperate with the driver so as to guide the driver in rotation;
said at least one movement preventing element is provided on the portion of the driveshaft that is configured to be received in the driver;
the driveshaft has at least one means for driving a transmission element of said device in rotation;
the driveshaft comprises a first part configured to be driven by the actuator;
the driveshaft comprises a second part configured to drive a transmission element of said device in rotation, the transmission element being configured to be arranged in at least one position in which it is rotationally coupled to the driver;
the portion of the driveshaft that is configured to be received in the driver and to cooperate with the driver is a joining part between the first and second parts of the drive shaft;
the transmission element is configured to be movable in translation between an engaged position, in which it is rotationally coupled to the driver, and a disengaged position, in which it is decoupled from the driver;
the element for preventing movement in translation is arranged on a joining part between the first and second parts of the driveshaft;
the second part of the driveshaft has an elongate overall shape in section and is configured to be received in a housing of complementary elongate overall shape of the transmission element;
the second part of the driveshaft has an oblong overall shape and is configured to be received in a housing of complementary oblong overall shape of the transmission element;
the second part of the driveshaft has at least one flat;
the second part of the driveshaft has at least two opposite flats;
the flats are on the long sides of the elongate shape of the second part of the driveshaft;
the driveshaft has a cavity configured to at least partially receive a member made of shape memory material configured to act on the transmission element;
said at least one member made of shape memory material is configured to deform between a first state and a second state;
said member made of shape memory material is configured to be arranged in the cavity so as to act on the transmission element in order to disconnect it from the driver if the actuator fails;
the cavity has an overall shape complementary to the shape of the member made of shape memory material;
the cavity has a contour with a substantially “eight”-shaped overall shape;
the cavity is formed in the second part of the driveshaft that is intended to cooperate with the transmission element;
   the driveshaft comprises a peripheral groove configured to receive a seal intended to be positioned at the interface with the driver.

The invention also relates to a corresponding control device comprising such a driveshaft.

The invention also relates to a frame comprising at least one flap configured to be moved between an open position and a closed position and a control device for controlling said at least one flap as defined above.

According to one aspect of the invention, the track holder is mounted on the frame in a rotationally retained manner. According to one embodiment, the track holder has an indexing member with at least one flat received in a complementary housing of the frame.

Further features and advantages of the invention will become more clearly apparent from reading the following description, which is given by way of nonlimiting illustrative example, and from the appended drawings, in which:

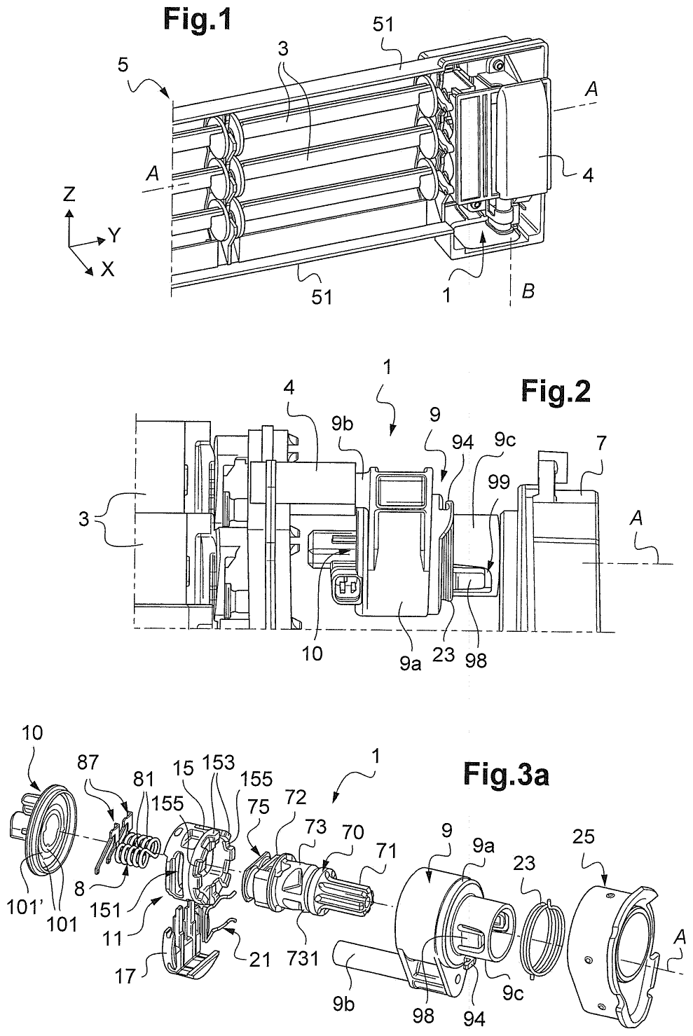

FIG. 1 shows a perspective view of a frame comprising a flap control device,

FIG. 2 shows a side view of the flap control device and an actuator,

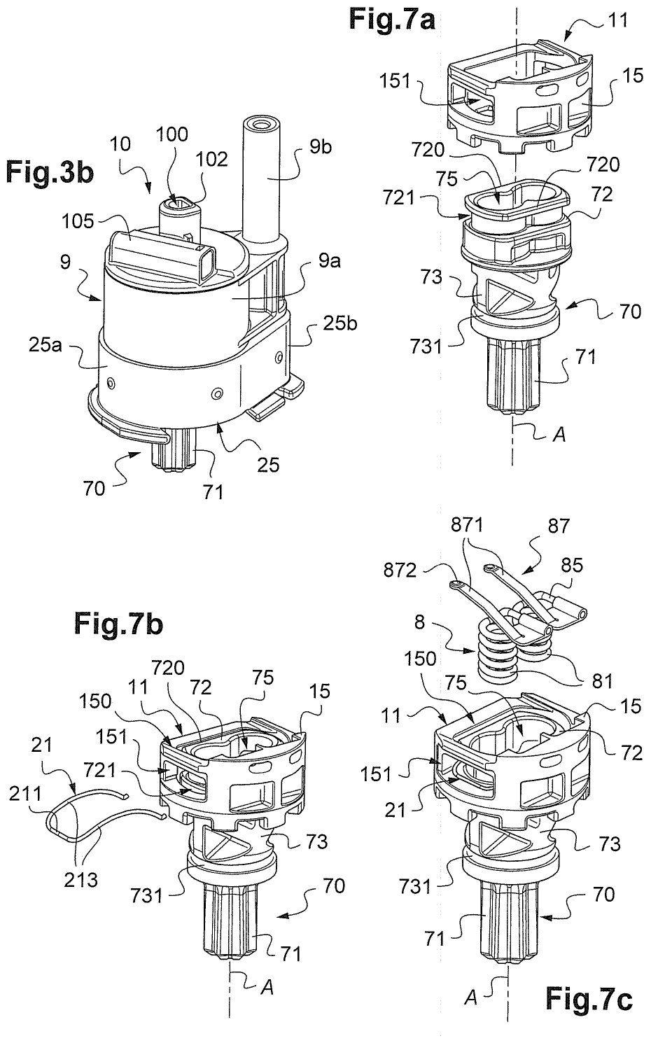

FIG. 3a is an exploded view of an engagement and disengagement mechanism of the device in FIG. 2,

FIG. 3b is a view in the assembled state of the engagement and disengagement mechanism in FIG. 3a,

FIG. 4 shows a member made of shape memory material of the mechanism in FIG. 3a,

FIG. 5 shows the member made of shape memory material in FIG. 4 connected to an associated track holder,

FIG. 6 shows an exemplary embodiment of conductive tracks,

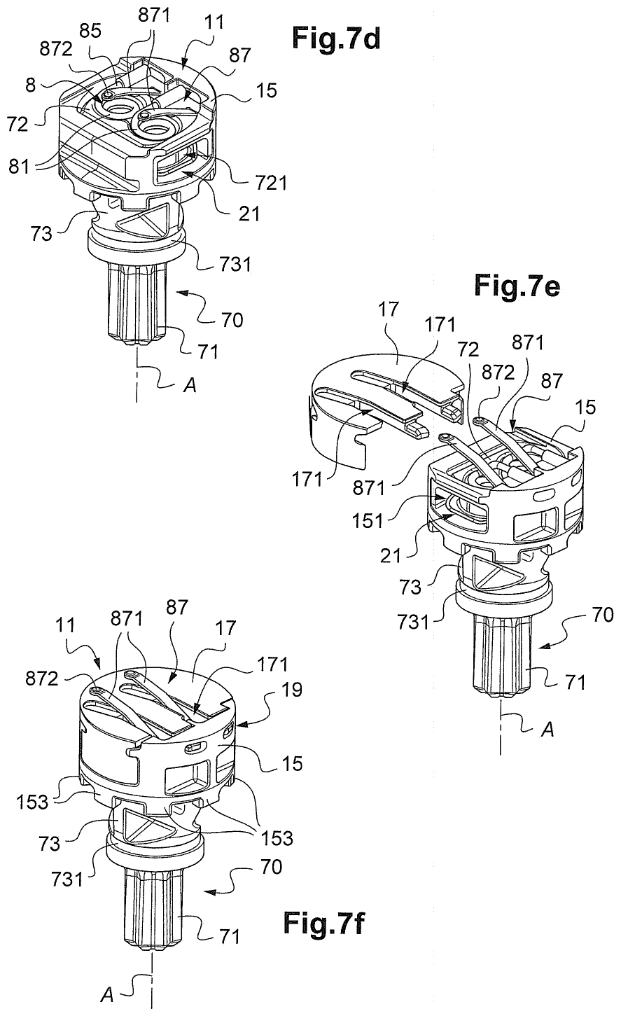

FIG. 7a is an exploded view of a complementary driveshaft and transmission element body of the mechanism in FIG. 3a,

FIG. 7b shows the elements in FIG. 7a and an elastic return element before assembly,

FIG. 7c shows the elements in FIG. 7b assembled and the member made of shape memory material in FIG. 4 before assembly,

FIG. 7d shows the elements in FIG. 7c assembled,

FIG. 7e shows the elements in FIG. 7d and a cap of the transmission element before assembly,

FIG. 7f shows the elements in FIG. 7e assembled,

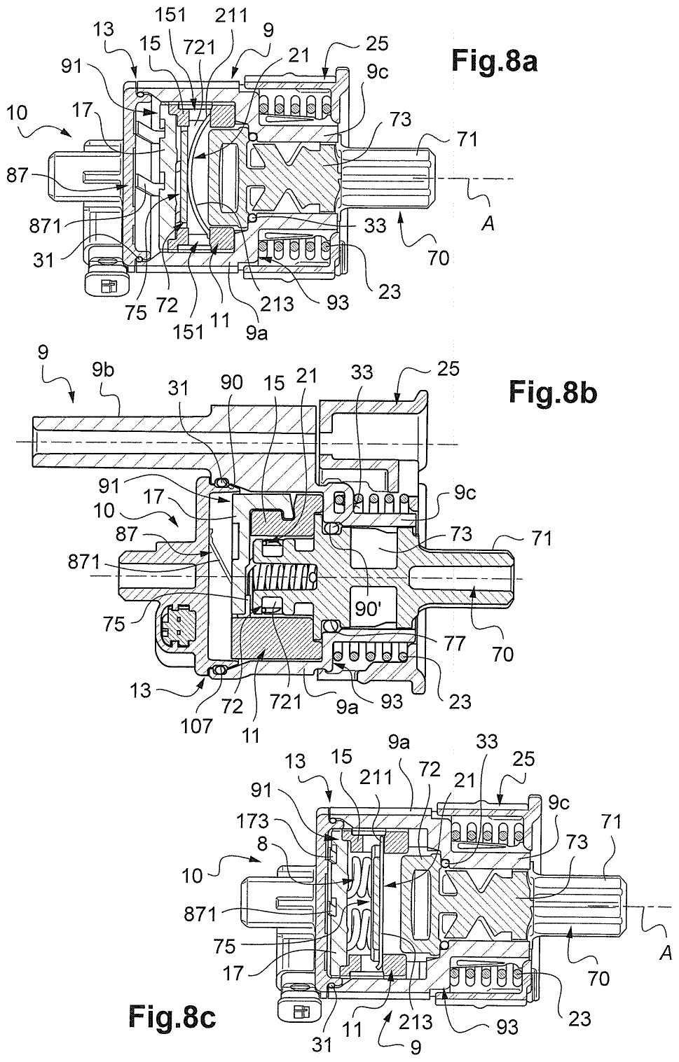

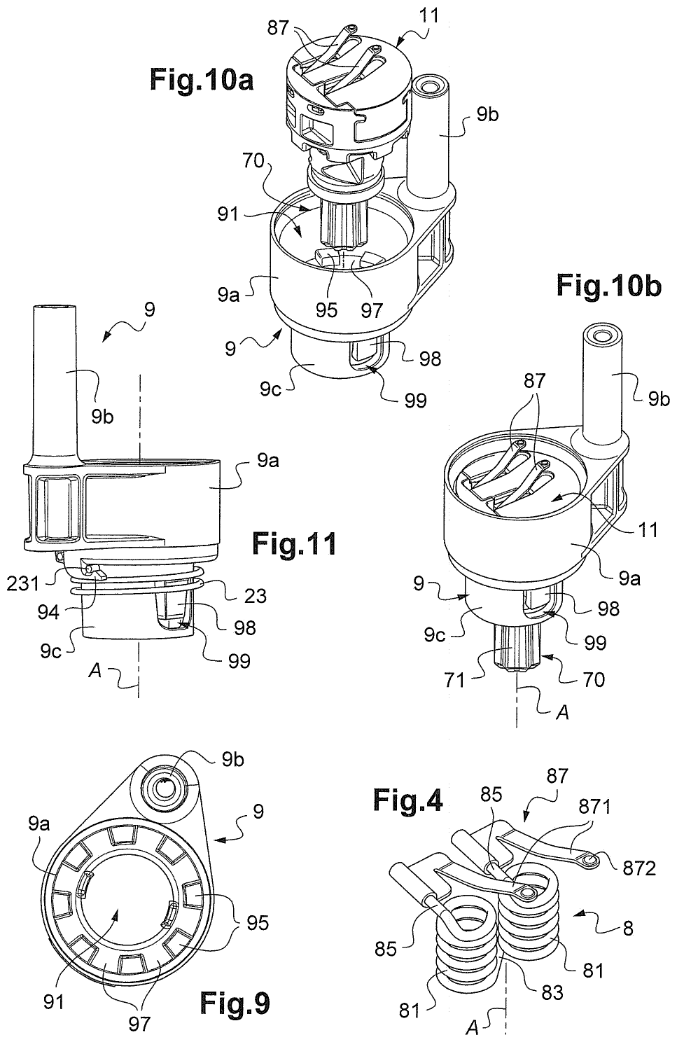

FIG. 8a is a partially cross-sectional view showing the mechanism in FIG. 2 assembled with the transmission element in an engaged position,

FIG. 8b is another cross-sectional view showing the mechanism in FIG. 2 assembled with the transmission element in an engaged position,

FIG. 8c is a partially cross-sectional view showing the mechanism in FIG. 2 assembled with the transmission element in a disengaged position,

FIG. 9 is a view of a driver of the mechanism in FIG. 2,

FIG. 10a shows the elements in FIG. 7f before assembly in the driver, and

FIG. 10b shows the elements in FIG. 10a after assembly,

FIG. 11 is a perspective view of a driver of the mechanism in FIG. 3a,

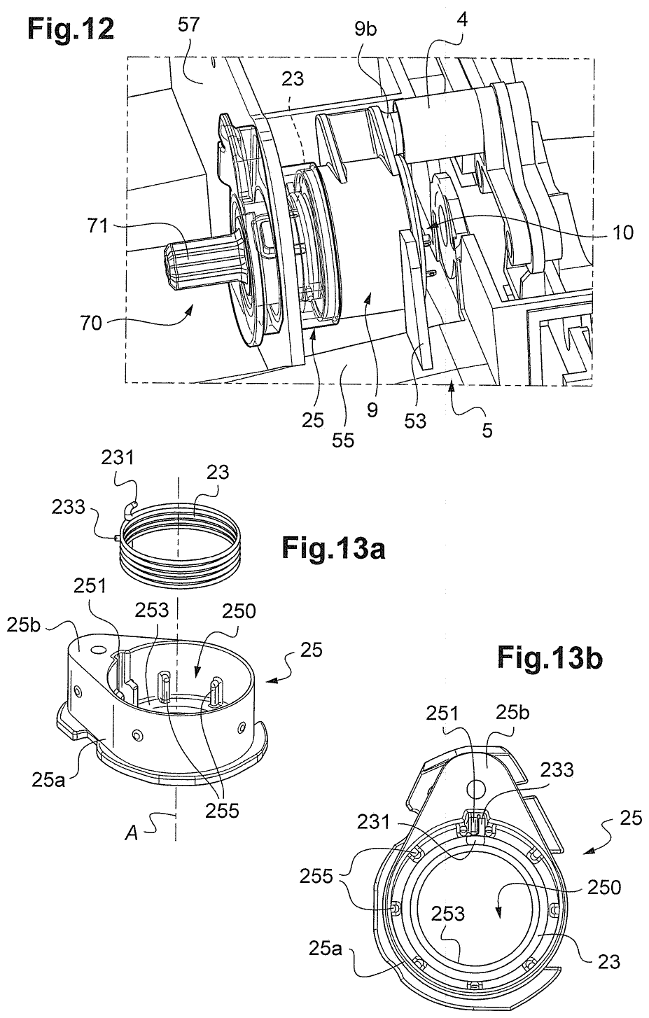

FIG. 12 shows the mechanism in FIG. 3a assembled on the frame,

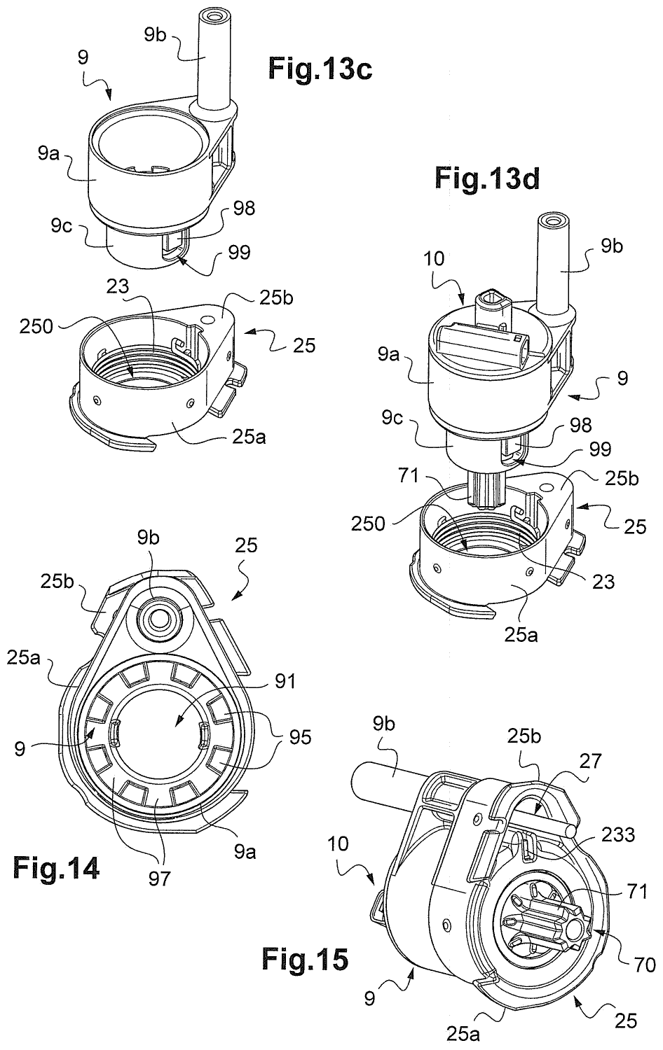

FIG. 13a is an exploded view of a base and a return member of the mechanism in FIG. 3a,

FIG. 13b is a top view of the elements in FIG. 13a assembled,

FIG. 13c shows the elements in FIG. 13a assembled and the driver before assembly,

FIG. 13d shows, before assembly, for the one part the elements in FIG. 13b assembled and for the other part the driver receiving the driveshaft and the closure cap,

FIG. 14 is a top view of the base and the driver assembled, and

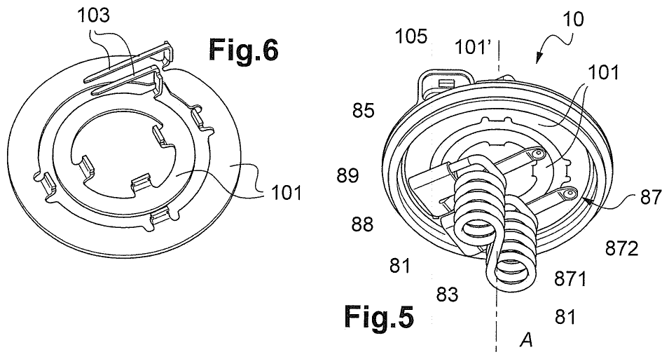

FIG. 15 is a perspective view of the mechanism in FIG. 3a.

In these figures, substantially identical elements bear the same references.

The following embodiments are examples. Although the description refers to one or more embodiments, this does not necessarily mean that each reference relates to the same embodiment, or that the features apply only to a single embodiment. Individual features of different embodiments can also be combined or interchanged in order to create other embodiments.

The horizontal plane is denoted by a reference frame (X, Y) and the vertical direction by the direction Z, the three directions forming a trihedron (X, Y, Z). These axes may correspond to the designation of the axes in a motor vehicle, i.e. by convention, in a vehicle, the X axis corresponds to the longitudinal axis of the vehicle, the Y axis corresponds to the transverse axis of the vehicle and the Z axis to the vertical axis over the height of the vehicle.

In the present description, the terms vertical/horizontal or top/bottom refer to the disposition of the elements in the figures, which corresponds to the disposition of the elements in the mounted state in the motor vehicle.

As is known, a motor vehicle has one or more air intakes provided at the front of the motor vehicle. The term front in this case refers to the direction of travel of the motor vehicle.

With reference to FIG. 1, the invention relates to a control device 1 for controlling one or more flaps 3, in particular for a motor vehicle. The control device 1 is intended to be arranged in the region of an air intake of the motor vehicle.

Generally placed behind or downstream of the control device 1 is a heat exchange device (not shown) of the motor vehicle, through which a flow of air introduced through the air intake(s) at the front of the vehicle is intended to pass.

The control device 1 may have at least one flap 3 that is movable between an open position and a closed position. These are extreme positions, the flap(s) 3 being able to take up intermediate positions between these two, open and closed positions.

To this end, an actuator 7 (partially visible in FIG. 2) is provided to drive the flap(s) 3 in movement between the open and closed positions. The actuator 7 may or may not be an integral part of the flap control device 1. By way of example, the actuator 7 can be controlled pneumatically, electrically or mechanically.

According to the example illustrated in FIG. 1, when the flaps 3 are in the open position and in the state mounted on the vehicle, the air intake is freed up. When the flaps 3 are in the closed position (not shown), the air intake is obstructed.

The flap(s) 3 is/are for example rotatable. Advantageously, in the case of a plurality of flaps 3, the flaps 3 can be able to move with one and the same defined rotary movement about a driving axis or axis of rotation represented by the axis A. The rotation of the flaps 3 can take place in both directions about the axis of rotation A. The axis of rotation A is parallel to the transverse axis Y in the example illustrated. According to an alternative that is not shown, it is possible to provide for the flap(s) 3 to be moved for example in translation between the open and closed positions.

Furthermore, the control flaps 3 can be connected by a connecting member 4. The connecting member 4 is configured to move, for example in translation, and, on moving, it can drive the simultaneous pivoting of all the flaps 3. According to the example shown in FIG. 1, the connecting member 4 is configured to move in translation along an axis B. The translation axis B is for example parallel to the vertical axis Z. The connecting member 4 can be driven in both directions, i.e. in this case downward or upward along the vertical axis Z.

This control device 1 is mounted on a frame 5 in the example illustrated. The frame 5 may correspond to a framework having two longitudinal sides 51 and two lateral sides (not visible in the figures) for a given thickness. The longitudinal sides 51 of the frame 5 extend in this case along the transverse axis Y and the lateral sides along the vertical axis Z. In the example illustrated, the frame 5 has a substantially rectangular overall shape with two longitudinal long sides 51 and two lateral short sides. Any other shape of the frame 5 can be envisioned, the invention not being limited to the shape of the frame 5.

With reference to FIGS. 1 to 3a, in the event of a fault, for example following failure of the actuator 7, the control device 1 has one or more elements for disconnecting the flap(s) 3 from the actuator 7.

In particular, the control device 1 has at least one member 8 made of shape memory material (visible more particularly in FIG. 3a). The member 8 made of shape memory material is configured to be supplied with electric power so as to deform between a first state and a second state. This change in state can take place if the actuator 7 fails. The member 8 made of shape memory material is therefore able to be connected to an electric power source (not shown).

The member 8 made of shape memory material is configured to change state if the actuator 7 fails. This member 8 made of shape memory material is designed so as to disconnect the flap(s) 3 from the actuator 7 when it passes from one state to another, in particular from the first state to the second.

When it is compressed, the member 8 made of shape memory material can pass from a compressed or shrunk state to an expanded state and vice versa. When it is compressed, the member 8 made of shape memory material can expand or lengthen by a predefined distance. By way of nonlimiting example, a member 8 made of shape memory material having a shrinkage coefficient of around 2% to 8%, preferably around 4%, can be provided.

If the actuator 7 fails only temporarily, when the failure ceases, the member 8 made of shape memory material can return to the starting or rest state, for example to the compressed state.

According to one variant, the member 8 made of shape memory material could be supplied with power permanently during fault-free operation. In this case, the electric power supply to the member 8 made of shape memory material is stopped if the actuator 7 fails. Provision could be made to combine the power supply to the member 8 made of shape memory material and the power supply to the actuator 7. In a variant, the power supply to the member 8 made of shape memory material may be independent of that of the actuator 7.

According to a variant that uses less power and is more economical than the above, the member 8 made of shape memory material can, by contrast, be supplied with power if the actuator 7 fails. In this case, during normal fault-free operation, the member 8 made of shape memory material is not supplied with power.

Provision may be made, for example, for the member 8 made of shape memory material, when it is supplied with power, to be in its compressed form and, when it is no longer supplied with power, to return to its expanded form in the rest state and to regain its original length. Or, by contrast, provision may be made for the member 8 made of shape memory material, when it is supplied with power, to be in its expanded form and, when it is no longer supplied with power, to return to its compressed form in the rest state. This is the preferred embodiment variant.

The member 8 made of shape memory material may comprise at least one spring.

In particular, as illustrated in FIGS. 4 and 5, the member 8 made of shape memory material may comprise two springs 81, for example coil springs, that meet at one end 83. In other words, the two springs 81 have a common end 83. It is also possible to speak of double winding 81 for forming the member 8 made of shape memory material. The free ends 85 of the two springs 81, that is to say on the opposite side from the common end 83, can be configured to be connected to the electric power source (not shown).

The design of the member 8 made of shape memory material is not limited to this particular example. Any other form of the member 8 made of shape memory material may be envisioned. By way of example, a wire made of shape memory material can be provided, which can be substantially straight or have a curved or spiral shape at least in one portion.

The control device 1 additionally has one or more electrical connection means for connecting the member 8 made of shape memory material to the electric power source (not shown).

According to the embodiment illustrated, the control device 1 has a track holder 10, more clearly visible in FIG. 5. The track holder 10 is mounted in the control device 1 in a rotationally retained or rotationally indexed manner. The track holder 10 can be mounted on the frame 5 (not visible in FIG. 5), so as to be prevented from rotating. To this end, the frame 5 can have a support bearing to which the track holder 10 is fixed by any appropriate means. In a complementary manner, the cover 10 can have an indexing member 100 with at least one flat 102 (see FIG. 3b). The indexing member 100 is configured to be received in a housing of complementary shape on the frame 5 (not visible in FIG. 3b), allowing in particular the track holder 10 to move in translation with respect to the frame 5 for assembly and preventing the track holder 10 from being able to rotate with respect to the frame 5.

Referring again to FIG. 5, the holder 10 has at least two conductive tracks 101 for supplying electric power to the member 8 made of shape memory material.

In the example illustrated, two conductive tracks 101 are provided, one track for the positive pole and one track for the negative pole. By way of example, the conductive tracks 101 can, for example, be supplied with electric power if the actuator 7 fails. When the actuator 7 is disconnected from the flaps 3, the electric power supply to the conductive tracks 101 can be cut.

The conductive tracks 101 are made for example of brass. The conductive tracks 101 are on a face of the track holder 10 that is arranged facing the member 8 made of shape memory material in the assembled state of the control device 1. By way of nonlimiting example, the conductive tracks 101 can be overmolded on the track holder 10. The conductive tracks 101 can be arranged concentrically with a central axis. According to the embodiment illustrated, this central axis is coincident with the driving axis A.

A gap or space can be provided between the two tracks 101. For example, the conductive tracks 101 are separated by a nonconductive track 101′.

The conductive tracks 101 each have for example a connection terminal 103 (see FIG. 6). Each connection terminal 103 protrudes from the corresponding conductive track 101. In the example illustrated, making it possible in particular to obtain a compact control device, the connection terminals 103 can be curved.

In a complementary manner, referring again to FIGS. 4 and 5, the member 8 made of shape memory material has at least two contactor elements 87 that are each configured to come into electrical contact with an associated conductive track 101 at least under certain conditions, for example at least when the member 8 made of shape memory material is in the first state, in the rest state in this example.

The contactor elements are for example sliding contacts 87.

According to the particular example illustrated with a member 8 made of shape memory material realized by two springs or two windings 81 connected by a common end 83, a sliding contact 87 is connected to the opposite end 85 of each spring or winding 81 from the common end 83. The sliding contact 87 is connected at least electrically to the end 85 of the spring 81.

To this end, the control device 1 has a connection interface between the member 8 made of shape memory material and the sliding contact(s) 87. In particular, a plate 88 can be provided for each sliding contact 87, the sliding contact 87 extending therefrom. It is for example a flat or substantially flat plate 88.

Each plate 88 can have a sleeve 89 intended to receive the end 85 of the corresponding spring 81. The shape of the sleeve 89 is adapted to the shape of the end 85 of the spring 81. In a variant, any other shape can be envisioned for receiving an end of the member 8 made of shape memory material.

The sliding contacts 87 can each have a tongue 871 that extends from the plate 88 and terminates with an end 872. The tongues 871 are configured for example to extend along an inclined direction with respect to the general plane defined by the plate 88, when the member 8 made of shape memory material is in the rest state, that is to say with the springs 81 compressed. The direction of extension of the tongues 871 is likewise inclined with respect to the driving axis A.

The sliding contacts 87 are able to move with respect to the track holder 10. In other words, the sliding contacts 87 can pass from one position to another with respect to the track holder 10 when the member 8 made of shape memory material changes state.

In particular, the sliding contacts 87 are at least partially flexible. More specifically, at least the tongues 871 are flexible.

Referring more particularly to FIG. 5, the member 8 made of shape memory material and the track holder 10 can be arranged such that the ends 872 of the sliding contacts 87 are in electrical contact with the conductive tracks 101.

When the member 8 made of shape memory material changes state, that is to say, in the example described, when the springs 81 pass from a compressed state to an expanded state, the plates 88 move toward the track holder 10 or are aligned substantially with the ends 872, and by contrast, when the springs 81 are compressed again, the plates 88 move away from the track holder 10. In other words, the inclination angle of the tongues 871 with respect to the plates 88 decreases when the springs 81 expand, thus moving toward the track holder 10, and, by contrast, increases when the springs 81 are compressed again, moving away from the track holder 10.

Thus, “flexible” is understood as meaning that the sliding contacts 87, in particular their tongues 871, can be subjected to a predetermined load, in this case bending, on account of the change in state of the member 8 made of shape memory material so as to pass from one position to another without breaking. The range of travel of the contactor elements 87 between the two positions is around the same as the range of movement of the member 8 made of shape memory material between its two states.

The sliding contacts 87 thus remain in contact with the conductive tracks 101 in order to ensure proper electrical contact therewith, regardless of the axial position of the member 8 made of shape memory material, in particular of the springs 81, with respect to the track holder 10.

Moreover, as is described in detail below, the member 8 made of shape memory material is mounted in an assembly that is rotatable about the driving axis A, while the track holder 10 remains rotationally retained. As a result, the sliding contacts 87 turn about the driving axis A following the complementary circular shape of the conductive tracks 101. In this way, a turning contactor for supplying power to the member 8 made of shape memory material is formed.

At least when the member 8 made of shape memory material is in the first state, in the rest state in this example, the sliding contacts 87 can be in contact with the conductive tracks 101, regardless of the angular position of the member 8 made of shape memory material with respect to the track holder 10. Thus, when the member 8 made of shape memory material is supplied with power, if the actuator 7 fails for example, electrical contact is ensured between the sliding contacts 87 and the conductive tracks 101, regardless of the angular position of the member 8 made of shape memory material.

According to an advantageous embodiment, the sliding contacts 87 are not configured to be arranged in continuous contact with the conductive tracks 101. In particular, the sliding members 87 can be configured and/or dimensioned such that, at the end of travel of the member 8 made of shape memory material, when the latter expands, at least one of the sliding contacts 87 or both sliding contacts 87 come(s) away from the conductive tracks 101. It is possible in particular to vary the outside diameter of the inner conductive track 101 and/or adapt the dimensions of one or both sliding contacts 87.

Thus, according to one embodiment, when the member 8 made of shape memory material is not supplied with power, it is in its compressed form and the sliding contacts 87 are in contact with the conductive tracks 101. If the actuator 7 fails, the member 8 made of shape memory material is supplied with power and deforms between the first state and the second state, that is to say expands in the example described. On expanding, the member 8 made of shape memory material participates in disconnecting the flaps 3 from the actuator 7, as is described in more detail below. The plates 88 move toward the track holder 10. The expansion of the member made of shape memory material continues, pressing the sliding contacts 87 against the track holder 10. At the end of travel of the member 8 made of shape memory material, at least one sliding contact 87 or both sliding contacts 87, more specifically the ends 872 thereof, have been moved so as to come away from the tracks 101. In particular, the ends 872 are then located in the space between the tracks 101, that is to say on the nonconductive track 101′. The contactor elements 87 are then in mechanical contact with the nonconductive intermediate track 101′ and without electrical contact (this configuration is not visible in FIG. 5).

The sliding contacts 87 coming away from the conductive tracks 101 thus stops the electric power supply to the member 8 made of shape memory material. This makes it possible to bring about an additional safety function. On cooling, the member 8 made of shape memory material then tends to return to the rest state, that is to say to return to its compressed form.

In addition, when the actuator 7 is disconnected from the flaps 3, the tracks 101 are no longer supplied with power. Thus, when the member 8 made of shape memory material is compressed such that the sliding contacts 87 are again in contact with an associated conductive track 101, since the electric power supply has been stopped, the member 8 made of shape memory material can return to the rest state, that is to say compressed in the example described.

Moreover, the holder 10 has for example an annular overall shape centered on the driving axis A. According to an advantageous configuration, the track holder 10 delimits a certain radial size and the sliding contacts 87 are arranged in the control device 1 without protruding radially with respect to the size delimited by the track holder 10. In other words, the sliding contacts 87 are arranged in the same radial size or with a radial size less than the track holder 10. The term “radial” is defined with respect to the driving axis A. The sliding contacts 87 are thus in alignment with the track holder 10.

Furthermore, the track holder 10 can also carry at least one electrical connector 105. The electrical connector 105 is provided on the opposite side from the conductive tracks 101. It is for example overmolded on the track holder 10. The connection terminals 103 lead into this electrical connector 105. The electrical connector 105 is intended to be connected to the electric power source (not shown) so as to make it possible to supply power to the conductive tracks 101, for example when a complementary electrical connector (not shown) is inserted into the electrical connector 105.

According to a variant that is not shown, it is conceivable for cables connected to the electric power source (not illustrated) to be connected to the track holder 10, for example soldered to the conductive tracks 101.

The track holder 10 can also be shaped so as to receive a seal 31 (as described below). It may be for example, as illustrated in FIG. 8b, a groove 107 in a peripheral skirt of the track holder 10. The peripheral skirt of the holder 10 extends in the direction of the transmission element 11 and the driveshaft 70 in the assembled state of the control device 1.

The cooperation of the member 8 made of shape memory material with the other elements of the control device 1 is described in more detail below.

The control device 1 can also have a driveshaft 70 (visible in FIG. 3a), which is arranged so as to transmit a movement from the actuator 7 to the flaps 3, also with reference to FIG. 2.

The control device 1 can also comprise, in this example, a driver 9 coupled to the flaps 3 and a transmission element 11, which can be rotationally coupled to or disconnected from the driver 9. Disconnection occurs if the actuator 7 fails under the action of the member 8 made of shape memory material.

As regards the driveshaft 70, it is configured to be driven by the actuator 7. The driveshaft 70 can be driven in rotation about the driving axis A.

This driveshaft 70 can have at least one means for driving the transmission element 11 of the control device 1 in rotation.

The driveshaft 70, which is more clearly visible in FIGS. 7a to 7f, comprises for example a first part 71 configured to be driven by the actuator 7 (not visible in these figures) and a second part 72 configured to cooperate with the transmission element 11.

The first 71 and second 72 parts extend for example longitudinally along the driving axis A.

The section of the first part 71 may have, in a nonlimiting manner, a star-shaped overall shape.

According to the embodiment described, the second part 72 is configured to be received in the transmission element 11.

The second part 72 is configured to drive the transmission element 11 in rotation. In other words, the second part 72 of the driveshaft 70 has the means for driving the transmission element 11 in rotation. The second part 72 may have, in a nonlimiting manner, an elongate overall shape, such as an oblong overall shape. This second part 72 additionally has at least one flat 720. According to the example in FIG. 7a, the second part 72 has at least two opposite flats 720. In this example of the driveshaft 70 with a second part 72 of elongate shape, such as an oblong shape, the flats 720 are arranged on the long sides of the second part 72 of the driveshaft 70. The second part 72 is configured to guide the movement of the transmission element 11, as will be described below.

In addition, this second part 72 can have, on its external contour, a peripheral groove 721 (more clearly visible in FIG. 7a).

The driveshaft 70 additionally comprises a joining part 73 between the first 71 and second 72 parts of the driveshaft 70. This joining part 73 is shaped so as to be received in the driver 9, as shown schematically in FIGS. 8a to 8c. This joining part 73 can act as a surface for guiding the rotation of the driver 9.

Moreover, the driveshaft 70 has at least one element 731 for preventing the driver 9 from moving in translation or axially.

The driver 9 can be prevented from moving in translation by snap-fastening. To this end, referring again to FIGS. 7a to 7f, the driveshaft 70 can have a peripheral groove 731 configured to cooperate with at least one complementary movement preventing element carried by the driver 9. This peripheral groove 731 is for example in the joining part 73. In this example, this groove 731 is closer to the first part 71 than to the second part 72.

Finally, the driveshaft 70 has a cavity 75 (see FIGS. 7a to 7c) for receiving the member 8 made of shape memory material. The cavity 75 is formed in the second part 72 of the driveshaft 70 that is intended to cooperate with the transmission element 11. This cavity 75 has a shape complementary to the shape of the member 8 made of shape memory material. By way of nonlimiting example, the cavity 75 has a contour with a substantially “eight”-shaped or peanut-shaped overall shape, or a kidney shape. This “eight” shape or peanut shape is designed to receive, at least partially, or entirely, the two joined springs 81 described above. The plates 88, the sleeves 89 and the contactor elements 87 at the ends of the springs 81 can extend outside this cavity 75.

The driveshaft 70 can also have a peripheral groove 77, as illustrated in the example in FIG. 8b. This peripheral groove 77 can be in the joining part 73 and is configured to receive a seal 33, as described below. This is in particular a seal 33 intended to be positioned at the interface with the driver 9.

As regards the driver 9, referring again to FIGS. 2, 3a and 3b, this can be a control lever 9. A driver 9 is understood to be any means or member that makes it possible transmit a movement to one or more flaps 3. To this end, the driver 9 is, for the one part, coupled directly or indirectly to at least one flap 3 and is, for the other part, configured to be driven by the actuator 7 via the driveshaft 70. With such an arrangement, the driver 9 can move the flap(s) 3 under the impetus of the actuator 7.

The driver 9 is for example coupled to at least one flap 3 or to the connecting member 4 by cooperation of shapes. With reference to the example in FIG. 2, the driver 9 can be coupled to the flaps 3 via the connecting member 4. Thus, in operation, the actuator 7 steers the rotation of the driver 9, which drives the movement of the connecting member 4 to which the flaps 3 are connected, which are thus in turn pivoted.

The shape of the driver 9 can be adapted depending on the control device 1 in which it is installed and on the actuator 7. With reference to FIGS. 8a to 10b, the driver 9 comprises a main body 9a through which the driveshaft 70 is intended to pass. The main body 9a has for example a cylindrical overall shape.

The driver 9 also comprises an arm 9b (more clearly visible in FIGS. 3a, 3b, 10a and 10b) configured to be coupled to at least one flap 3 for example via the connecting member 4 (see FIG. 2). According to the example illustrated in FIGS. 3, 10a and 10b, the arm 9b protrudes from a corner or side of the main body 9a. The arm 9b thus extends in an off-center manner. The arm 9b can extend axially in the direction of the flaps 3 or of the connecting member 4 for example. This configuration is not limiting. This configuration is advantageous for example when the actuator 7 is intended to be positioned on the side of the control device 1.

According to an alternative that is not shown, the driver 9 can have an extension substantially in the form of a fork that is intended to be connected to the flap(s) 3 or to the connecting member 4. Such a configuration may be advantageous when the actuator 7 is intended to be positioned at the center of the control device 1.

The driver 9 additionally has a portion 9c that extends from the main body 9a on the opposite side from the arm 9b. This portion 9c has for example a tubular overall shape. The portion 9c extends for example centrally, from a face of the main body 9a. The portion 9c has a smaller diameter than the main body 9a.

With reference to FIGS. 9a to 10b, the driver 9 has a cavity defining a housing 91 in which the driveshaft 70 and the transmission element 11 are at least partially arranged. This cavity is provided in the main body 9a. This main body 9a can have a shoulder 93 acting as a contact and stop surface for the driveshaft 70, in particular the second part 72 of the driveshaft 70. Thus, the first part 71 of the driveshaft 70 can extend at least partially outside the driver 9 in order to be fitted to the actuator 7, while the second and third parts 72, 73 can be housed inside the driver 9.

Referring more particularly to FIGS. 8a to 8c, in order to obtain a sealed device 1, a seal 31 can be arranged at the interface between the driver 9, more particularly the main body 9a of the driver 9, and the track holder 10. This is advantageously an O-ring that is capable of functioning in movement. To this end, the driver 9 can have a peripheral groove 90 intended to be arranged opposite and to cooperate with the groove 107 in the peripheral skirt of the track holder 10 in order to hold the seal 31.

Similarly, a seal 33 can be arranged at the interface between the driver 9 and the driveshaft 70, more particularly between the portion 9c of the driver 9 and the third part 73 of the driveshaft 70. This is advantageously an O-ring that is capable of functioning in movement. To this end, the driver 9 can have another peripheral groove 90′ intended to be arranged opposite and to cooperate with the peripheral groove 77 in the joining part 73 in order to hold the seal 33.

As shown schematically in FIG. 9, the driver 9 additionally has a plurality of teeth 95 alternating with a plurality of recesses 97. This is referred to more generally as a toothing. This toothing is provided on the internal surface of the main body 9a. More specifically, the toothing is provided so as to cooperate with the transmission element 11 (not visible in this figure) when it is received in the housing 91. In this example, the first teeth 95 do not extend over the entire height of the main body 9a but only over a portion.

Referring again to FIGS. 2, 3a, 3b, 10a and 10b, the driver 9 can additionally have one or more elements for preventing the driveshaft 70 from moving. In this case, it is movement in translation along the driving axis A that is prevented. These movement preventing means can be arranged at the portion 9c of the driver 9. The movement preventing means can be realized by blocking tabs 98 configured to cooperate with the groove 731 in the driveshaft 70 (visible in FIGS. 7a to 7f). The blocking tabs 98 end for example in hooks. In this way, the driver 9 and the driveshaft 70 are assembled for example by clip-fastening or snap-fastening. By way of example, the portion 9c can have notches 99 that delimit the blocking tabs 98.

Finally, the driver 9 is intended to be fitted to the track holder 10 described above, as illustrated in FIGS. 8a to 8c. To this end, the control device 1 has complementary fastening member 13 means, such as clip-fastening or snap-fastening means, carried by the track holder 10, for the one part, and by the driver 9, for the other.

In the assembled state of the control device 1, the track holder 10 is arranged facing this housing 91, as schematically shown in FIGS. 8a to 8c. The track holder 10 can be fitted to the driver 9 so as to close the housing 91 on one side, in this case on the opposite side from the first part 71 of the driveshaft 70. The track holder 10 is thus arranged on the opposite side of the driver 9 from the actuator 7 (not visible in FIGS. 8a to 8c). The track holder 10 can thus form a cover for the driver 9. The track holder 10 can be fitted to the driver by any appropriate fastening means, such as by clip-fastening or snap-fastening.

Referring again to FIGS. 3a and 8a to 8c, the transmission element 11 can be realized by a clutch housing. This transmission element 11 is arranged to as to rotationally couple the driveshaft 70 and the driver 9 in normal operation (FIGS. 8a, 8b) and to be disconnected from the driver 9 if the actuator 7 fails (FIG. 8c). The expression “normal operation” in this case means a fault-free mode, without any failure of the actuator 7.

For this purpose, the transmission element 11 is mounted so as to be movable between an engaged position (FIGS. 8a, 8b) and a disengaged position (FIG. 8c). In this example, the transmission element 11 is mounted so to be movable axially, this to say movable in translation along the driving axis A.

In the engaged position (FIGS. 8a, 8b), the transmission element 11 can transmit a movement from the driveshaft 70 to the driver 9. The transmission element 11 is rotationally coupled to the driveshaft 70 and is rotationally coupled to the driver 9, thereby making it possible to couple the driver 9 and the actuator 7 via the driveshaft 70. The driver 9 can thus drive one or more flaps 3.

In the disengaged position (FIG. 8c), the transmission element 11 is disconnected from the driver 9. In this example, the transmission element 11 remains secured to the driveshaft 70 and is decoupled from the driver 9. The transmission element 11 thus makes it possible to disconnect the flaps 3 from the actuator 7 by being disconnected from the driver 9.

To this end, the member 8 made of shape memory material is arranged so as to urge the transmission element toward the disengaged position if the actuator 7 fails. More specifically, the member 8 made of shape memory material axially acts on the transmission element 11. In other words, when the actuator 7 is prevented from moving following a failure, the transmission element 11 can, under the effect of the action of the member 8 made of shape memory material, by moved in translation toward the disengaged position, independently of the driveshaft 70.

According to the particular example illustrated in FIG. 8a, as long as the member 8 made of shape memory material (not visible in FIG. 8a) is compressed, it does not urge the transmission element 11 toward its disengaged position. Thus, the transmission element 11 remains in the engaged position, the transmission element 11 being coupled to the driver 9.

By contrast, in the expanded state as illustrated in FIG. 8c, the member 8 made of shape memory material applies an axial stress to the transmission element 11, urging it toward the disengaged position (FIG. 8c), this causing the disconnection of the transmission element 11 and the driver 9 if the latter were previously secured to one another, or leaving the transmission element 11 in the disengaged position if the transmission element 11 was already disconnected from the driver 9.

According to one exemplary embodiment, when the member 8 made of shape memory material passes from one state to the other, i.e. expands or retracts, this corresponds to a movement of the transmission element 11 along a length of around 2 to 3 mm.

More specifically, as far as the cooperation of the transmission element 11 with the driveshaft 70 is concerned, the transmission element 11 is positioned around a portion of the driveshaft 70, that is to say, in this example, around an end portion that corresponds to the second part 72 of the driveshaft 70. This arrangement is brought about by cooperation of shapes between the transmission element 11 and the second part 72 of the driveshaft 70.

In addition, the second part 72 of the driveshaft 70, in particular the external surface facing the transmission element 11, is configured to guide the movement, in this example the sliding, of the transmission element 11 about the second part 72 between the engaged and disengaged positions. This is linear guidance.

According to the embodiment illustrated in FIGS. 3a and 7a to 8c, the transmission element 11 has a main body 15, which is arranged around the second part 72 of the driveshaft 70.

In particular, the transmission element 11 has a housing 150 (see FIGS. 7a to 7c) configured to receive the second part 72 of the driveshaft 70. In this example, this housing 150 is provided in the region of the main body 15 of the transmission element 11.

The housing 150 has an elongate overall shape complementary to the shape of the second part 72 of the driveshaft 70. The second part 72 of the driveshaft 70 is intended to be arranged in this housing 150 such that the flats 720 are disposed next to the long sides of the housing 150. This allows the driveshaft 70 to slide in the transmission element but prevents it from rotating. This makes it possible to transmit the torque from the actuator 7 to the driver 9 via the transmission element 11.

In addition, as illustrated in FIGS. 7c to 7e, the transmission element 11 can have at least one lateral opening 151, in this example two opposite lateral openings 151. The elongate, for example oblong, shape of the second part 72 of the driveshaft 70 makes it possible to orient the arrangement of the latter in the housing 150 of the transmission element, such that the short side of the second part 72 is positioned facing a lateral opening 151 in the transmission element 11. When the transmission element 11 and the driveshaft 70 are assembled, each lateral opening 151 is aligned with the peripheral groove 721 in the driveshaft 70 (more clearly visible in FIG. 7a).

Since the second part 72 of the driveshaft 70 having this cavity 75 is surrounded by the main body 15 of the transmission element 11, the member 8 made of shape memory material is at least partially inside the main body 15. As stated above, the springs 81 of the member 8 made of shape memory material are received in the second part 72 of the driveshaft 70 while the plates 88, the sleeves 89 and the contactor elements 87 extend outside this second part 72. In this case, the plates 88 and the sleeves 89 can be arranged in contact with a complementary contact surface provided for this purpose in the main body 15 of the transmission element 11.

The transmission element 11 additionally has an end wall arranged facing the end portion of the driveshaft 70, that is to say the second part 72.

As illustrated in FIGS. 7e and 7f, a closure cap 17 for the transmission element 11 can be provided, said cap 17 being fastened to the main body 15. Assembly is effected for example by cooperation of shapes between the main body 15 and the closure cap 17. Advantageously, complementary fastening means 19 (FIG. 7f) are provided, such as clip-fastening means for example, carried by the main body 15, for the one part, and by the closure cap 17, for the other.

In this case, the end wall is formed on this closure cap 17.

When the main body 15 and the closure cap 17 are assembled, the plates 88 and the sleeves 89 are disposed between the main body 15 and the closure cap 17. In other words, the arrangement of the closure cap 17 on the main body 15 makes it possible to sandwich the plates 88 and the sleeves 89 between the closure cap 17 and the main body 15.

The end wall, in this case the closure cap 17 of the transmission element 11 has at least two openings 171 for the contactor elements 87 of the member 8 made of shape memory material to pass through. These are longitudinal openings 171 with shapes complementary to the contactor elements 87, in particular the tongues 871, of the member 8 made of shape memory material. These openings 171 can be continued by housings 173. The terminal regions of the contactor elements 87, these terminal regions comprising the ends 872, can fit at least partially in the housings 173 when the springs 81 extend.

According to a variant that is not shown, it may be conceivable for the transmission element 11, that is to say the parts 15 and 17, to be made in one piece.

Furthermore, referring again to FIG. 3a, the control device 1 also has at least one elastic return element 21.

The elastic return element 21 is arranged so as to exert a return force urging the transmission element 11 toward the engaged position (FIG. 8a). This allows the coupling of the driver 9 and the actuator 7 under normal use conditions, that is to say in the absence of failure of the actuator 7. In this example, the transmission element 11 is acted upon axially.

When the member 8 made of shape memory material changes state and urges the transmission element 11 toward the disconnected position (FIG. 8c), for example when it expands, this is counter to the load exerted by the elastic return element 21.

In this example, the elastic return element 21 is arranged so as to act on the main body 15 of the transmission element 11.

By way of example, the elastic return element 21 can be realized in the form of a clip intended to enclose the drive shaft 70, in this case the second part 72, housed in the transmission element 11, while coming into contact with at least one surface of the transmission element 11. The elastic return element 21, for example in this clip form, thus makes it possible to link the driveshaft 70 and the transmission element 11.

The clip, which is more clearly visible in FIG. 7b, has a base 211 from which two tabs 213 extend in a parallel or substantially parallel manner. In the example illustrated, the tabs 213 are curved when the clip is in the rest state (FIGS. 7b and 8a). When the member 8 made of shape memory material changes state and urges the transmission element 11 toward the disengaged position (FIG. 8c), the clip is compressed such that the tabs 213 extend substantially in the same plane as the base 211 of the clip.

With reference to one of FIGS. 7c to 7e, the lateral opening 151 in the transmission element 11 allows the insertion of the elastic return element 21. Once introduced via this opening 151, the elastic return element 21, for example in the form of a clip, engages partially around the second part 72 of the driveshaft 70. With reference to FIGS. 7b and 8a to 8c, the tabs 213 of the clip are arranged in the peripheral groove 721 in the second part 72 of the driveshaft 70. The height of the peripheral groove 721 is thus adapted to the curvature of the tabs 213 in this example. The base 211 of the clip comes in to contact with a surface delimiting a lateral opening 151 in the transmission element 11. In a complementary manner, the ends of the tabs 213 of the clip can come into contact with a surface delimiting an opposite lateral opening 151 in the transmission element 11.

Furthermore, as far as the cooperation of the transmission element 11 with the driver 9 is concerned, the transmission element 11, in particular the main body 15, can be coupled to the driver 9 by cooperation of shapes in normal operation. According to the embodiment described, the transmission element 11 is configured to mesh with the driver 9 in normal operation. To this end, with reference to FIG. 3a, the transmission element 11 has a toothing complementary to the toothing of the driver 9. This toothing is provided on a face of the main body 15 arranged on the side of the driver 9. The toothing of the transmission element 11 is configured to cooperate with the toothing of the driver 9 so as to rotationally couple the driver 9 and the transmission element 11 in the engaged position. The toothing of the transmission element 11 comprises a plurality of teeth 153 alternating with a plurality of recesses 155. The teeth 153 of the transmission element 11 are configured to interlock with the teeth 95 (not visible in FIG. 3a) of the driver 9 so as to secure the transmission element 11 and the driver 9 together so that they rotate as one.

In the disengaged position of the transmission element 11, the toothing thereof is disengaged from the toothing of the driver 9.

Furthermore, the disconnection between the flaps 3 and the actuator 7 caused by the disconnection between the transmission element 11 and the driver 9 can be reversible. In other words, the driver 9 and the transmission element 11 can return to the engaged position in which they are secured together for example when the failure of the actuator 7 was only temporary, in order to return to a fault-free normal operation configuration.

The member 8 made of shape memory material is thus mounted and held in an assembly that is movable about the driving axis A, with respect to the track holder 10 which for its part is rotationally retained. This movable assembly is formed by the driveshaft 70 and the transmission element 11, more specifically by the second part 72 of the driveshaft 70, and the main body 15 and the closure cap 17 of the transmission element 11. This movable assembly is itself mounted in the driver 9, which is likewise movable (FIGS. 8a to 8c, 10a and 10b).

These elements form an engagement and disengagement mechanism for coupling or disconnecting the transmission element 11 and the driver 9. The driver 9 houses a part of this mechanism.

Failure Free Normal Operating Mode

Thus, in a normal, that is to say fault-free, operating mode, without failure of the actuator 7, the actuator 7 drives the movement of the flaps 3, in this example via the connecting member 4 (FIGS. 1 and 2).

With reference to FIG. 8a or 8b, the elastic return element 21 is in the rest state, and the member 8 made of shape memory material is not supplied with power and is compressed. The sliding contacts 87 can be arranged in contact with the tracks 101 (see FIG. 5). As long as the member 8 made of shape memory material remains in the compressed state, the transmission element 11 is kept coupled to the driver 9 by virtue of the return force exerted by the elastic return element 21.

The actuator 7 (not visible in FIG. 8a), under the effect of a drive, drives the rotation of the driveshaft 70 rotationally coupled to the transmission element 11; since the driver 9 being secured to the transmission element 11, it takes on the same rotary movement. The connecting member 4 (see FIG. 2) is in turn driven by the driver 9 and drives, in this case simultaneously, the pivoting of the flaps 3 for changing position.

Operating Mode if the Actuator Fails

If the actuator 7 happens to fail, for example when the actuator 7 is no longer supplied with power as a result of a short circuit or the wiring harness being cut or as a result of the electric drive not operating, or in the case of internal breakage of an element of the actuator 7, the connecting member 4 and thus the flaps 3 are disconnected from the driveshaft 70 and thus from the actuator 7 (with reference to FIGS. 2 and 3).

More specifically, the member 8 made of shape memory material 8 can be supplied with electric power via conductive tracks 101 of the track holder 10 (see FIG. 5), and deformed between the first state and the second state, that is to say, in the example described, that it can expand or lengthen by a sufficient distance to decouple the transmission element 11 and the driver 9. Specifically, upon expanding, the member 8 made of shape memory material acts on the transmission element 11, which moves toward the disengaged position (FIG. 8c) and is thus disconnected from the driver 9. In this example, the toothings provided on the transmission element 11 and the driver 9, respectively, are disengaged from one another.

In addition, referring again to FIG. 5, while the expansion of the member 8 made of shape memory material continues, the plates 88 move toward the track holder 10, advantageously until, at the end of travel of the member 8 made of shape memory material, the ends 872 come away from the tracks 101 and come into mechanical contact with the nonconductive track 101′, without electrical contact. The sliding contacts 87 coming away from the tracks 101 thus stops the electric power supply to the member 8 made of shape memory material. Thus, the sliding contacts 87 are only supplied with electric power to the minimum extent necessary to disconnect the driver 9 and the transmission element 11, that is to say long enough for the toothing of the transmission element 11 to disengage from that of the driver 9.

The driver 9 is disconnected from the transmission element, which is itself coupled to the driveshaft 70, which is secured to the actuator 7.

The driver 9, once disconnected from the actuator 7, is free to rotate. It can thus adopt a configuration in which the flaps 3 are in an open position allowing air to pass through the frame 5. The change in position of the flaps 3 can be obtained in various ways. For example, a return means such as a return spring arranged so as to urge the flaps 3 into the open position can be provided.

When the actuator 7 is disconnected from the flaps 3, the tracks 101 (see FIG. 5) are no longer supplied with power. For its part, on cooling, the member 8 made of shape memory material returns to the compressed state.

As long as the actuator 7 does not transmit a rotational movement to the driveshaft 70 again, the driver 9 remains in the position opening the flaps 3.

If the actuator 7 comes back into operation, provision can be made for the transmission element 11 to be able to be secured to the driver 9 again. The device 1 could then be repositioned in its initial configuration. Specifically, as soon as the actuator 7 starts to move again, the teeth 95 of the driver 9 return to facing the recesses 155 of the toothing on the transmission element 11.

Therefore, the device according to the present invention has the advantage, in a situation in which the actuator 7 has failed, of making it possible to return into a configuration in which the flaps 3 are in an open position without there being a need for external intervention. Specifically, the toothing incorporated in the main body 9a of the driver 9 can cooperate with the complementary toothing of the transmission element 11 and is part of the engagement and disengagement mechanism for coupling or disconnecting the transmission element 11 and the driver 9 if the actuator 7 fails.

Moreover, the arrangement of the member 8 made of shape memory material acting axially on the transmission element 11 inside the second part 72 of the driveshaft 70, which is itself inside the transmission element 11 while allowing this transmission element 11 to be guided between the engaged and disengaged positions, gives said mechanism a certain compactness.

Since the track holder 10 is rotationally retained or indexed, this makes the supply of electric power to the member 8 made of shape memory material more reliable, even though the latter is secured to the driveshaft 70 and the transmission element 11 so as to rotate as one therewith. Specifically, the sliding contacts 87 of the member 8 made of shape memory material come into electrical contact with the conductive tracks 101, which remain rotationally retained. Such an electrical connection entails no risk of any power supply cables of the member 8 made of shape memory material being damaged, which would likewise be driven in rotation according to the solutions of the prior art.

In addition, the sliding contacts 87 are only supplied with electrical power for the time necessary for the member 8 made of shape memory material to expand in order to disconnect the transmission element 11 from the driver 9, in this way providing a degree of additional safety.

Finally, by closing the housing 91 of the driver 9 in which the transmission element 11, the driveshaft 70 and the member 8 made of shape memory material are housed, the track holder 10 protects the assembly.

In addition, the arrangement of one or more seals 31, 33 between the driver 9 and the track holder 10, for the one part, and the driveshaft 70, for the other, makes it possible to ensure the sealing of the assembly.

The driver 9 has a holding element 94 (FIG. 11), such as a holding hook or lug, for the elastic return member 23, as will be described in more detail below. In the particular example shown, the holding element 94 protrudes from the face of the main body 9a from which the, for example tubular, portion 9c extends. This is a circular face in the example of the cylindrical main body 9a.

The track holder 10 is mounted in a rotationally retained manner in the control device 1. The track holder 10 can be mounted on the frame 5 (see FIG. 12), so as to be prevented from rotating. To this end, the frame 5 can have a support bearing 53 to which the track holder 10 is fixed by any appropriate means. In a complementary manner, the cover 10 can have an indexing member 100 with at least one flat 102 (see FIG. 3b). The indexing member 100 is configured to be received in a housing of complementary shape on the frame 5 (not visible in FIG. 3b), allowing in particular the track holder 10 to move in translation with respect to the frame 5 for assembly and preventing the track holder 10 from being able to rotate with respect to the frame 5.

In particular, the elastic return means 23 is arranged around the, for example tubular, portion 9c of the driver 9.

The elastic return means 23 can be realized in the form of a return spring, such as a torsion spring, likewise bearing the reference 23 below.

The two ends 231, 233 of the spring 23 can extend in one and the same direction or in two different directions. At least one end 233 of such a spring 23 can extend in a direction normal to the driving axis A.

The directions of extension of the ends 231, 233 of the spring 23 are adapted depending on the complementary holding elements provided on the driver 9, for the one part, and on the fixed element of the control device 1, for the other.

The holding element 94, such as a holding hook or lug provided on the driver 9, makes it possible to hold one of the ends 231 of such a spring 23 (see FIG. 11).

The control device 1 additionally has a base 25 arranged in a fixed manner in the device 1.

The base 25 can be fixed to the frame 5 (see FIG. 12). To this end, the frame 5 can have another support bearing 57 having an opening for the base 25 to pass through and be fixed. This support bearing 57 can extend in a manner parallel or almost parallel to the support bearing 53 for fixing the track holder 10.

The elastic return member 23, which is visible by transparency in FIG. 12, is fixed to the driver 9 on one side and to the base 25 on the other.

When the control device 1 is assembled, the portion 9c of the driver 9 is received in the base 25 and the elastic return member 23 is arranged between the driver 9 and an internal wall of the base 25. With such an arrangement, the elastic return member 23 is protected by the base 25.

The driver 9 is fitted to the base 25 while remaining rotatable with respect to the base 25, which remains fixed.

The base 25, which is more clearly visible in FIGS. 11a to 11d, has an internal space 250 for receiving the portion 9c of the driver 9. The internal space 250 of the base 25 has a complementary shape to the portion 9c. More generally, the base 25 can have an overall shape complementary to the overall shape of the driver 9.

For example, the base 25 has a main body 25a of cylindrical overall shape. The base 25 can have a fixing protrusion 25b that extends radially with respect to the main body 25a.

In a delivery position (see FIG. 15) before assembly on the frame 5 (not visible in this figure), the driver 9 and the base 25 can be assembled such that the fixing protrusion 25b is aligned with the arm 9b of the driver 9. A pin 27 can be inserted into corresponding openings in the fixing protrusion 25b and in the driver 9, for positioning and immobilizing the driver 9 and the base 25 in this delivery position.

Furthermore, the driver 9 alone can be fitted to the base 25 (FIG. 13c) first before in turn receiving the driveshaft 70, the transmission element 11, the member 8 made of shape memory material, or even the holder 10, which are not visible in FIG. 13c. In a variant, it is the entire assembly of the driver 9, which has already received the driveshaft 70, the transmission element 11, the member 8 made of shape memory material, or even the holder 10, that can be mounted in the base 25 (FIG. 13d).

In addition, when the drive shaft 70 is mounted in the driver 9, the first part 71 of the driveshaft 70 protrudes from the base 25 (FIG. 15) to allow it to be coupled to the actuator 7, which is not shown in this figure.

The base 25 also has at least one holding element, for example a holding slot 251, for one of the ends 233 of the return spring 23, as is more clearly visible in FIG. 13b. The holding slot 251 is provided in the internal wall of the base 25, which delimits the internal space 250 for receiving the driver 9. The holding slot 251 extends for example longitudinally in a manner parallel or almost parallel to the driving axis A. The holding slot 251 can extend over all or almost all of the height the base 25 along the driving axis A. This makes it easier to arrange the return spring 23 in the base 25 with the end 233 which is received in the slot 251.

With reference to FIGS. 11a and 11b, the base 25 can have a shoulder 253. This shoulder 253 can form a contact surface for the return spring 23. The base 25 thus exhibits a change in diameter.

The base 25 can also have at least one means for positioning the return spring 23. This is for example a boss 255 or a plurality of bosses 255 distributed over the inner surface of the base 25. The or each boss 255 extends radially over a distance that corresponds to the difference between the outside diameter of the return spring 23 and the inside diameter of the part of the base 25 that receives the return spring 23. In the example illustrated, the boss(es) 255 do(es) not extend over the entire height of the base 25, along the driving axis A, but only over a portion thereof.

In the example shown, the boss(es) 25 extend(s) from the shoulder 253 in the direction of the main body 9a of the driver 9 (see FIGS. 11c, 11d) of the assembly.

1. A control device for a motor vehicle, for controlling at least one flap configured to be moved between an open position and a closed position by an actuator, said control device comprising:
at least one member made of shape memory material configured to be supplied with electric power so as to deform between a first state and a second state in order to disconnect said at least one flap from the actuator if the actuator fails; and
a track holder having at least two conductive tracks for supplying said at least one member made of shape memory material with electric power,
wherein said at least one member made of shape memory material has at least two contactor elements configured to each be arranged in electrical contact with an associated conductive track at least when said at least one member made of shape memory material is in the first state.

2. The device as claimed in claim 1, wherein:
said at least two conductive tracks of said holder are separated by a nonconductive track, and
said contactor elements are configured such that, at the end of travel of said at least one member made of shape memory material that deforms between the first state and the second state when it is supplied with electric power, at least one of said contactor elements is moved so as to come into mechanical contact with the nonconductive track.

3. The device as claimed in claim 1, wherein said at least one member made of shape memory material is mounted so as to be rotatable about a driving axis with respect to the track holder.

4. The device as claimed in claim 3, wherein:
the holder has an annular overall shape that is centered on the driving axis and has a predefined radial size, and
said at least two contactor elements are configured with a radial size smaller than or around the same as the radial size of the track holder.

5. The device as claimed in claim 1, wherein the contactor elements are realized by sliding contacts.

6. The device as claimed in claim 1, further comprising a driveshaft configured to be arranged so as to transmit a movement from the actuator to said at least one flap, the driveshaft having a cavity for receiving said at least one member made of shape memory material.

7. The device as claimed in claim 6, further comprising:
a driver configured to be coupled to said at least one flap; and
a transmission element that is rotationally coupled to the driveshaft and mounted so as to be movable between:
an engaged position, in which it is rotationally coupled to the driver, and
a disengaged position, in which it is decoupled from the driver,
said at least one member made of shape memory material being configured to urge the transmission element toward the disengaged position if the actuator fails.

8. The device as claimed in claim 7, wherein:
the driver has a housing in which the driveshaft and the transmission element are at least partially arranged, and wherein
the track holder is fitted to the driver so as to close the housing.

9. The device as claimed in claim 8, having at least one seal arranged at the interface between the driver and the track holder and/or between the driver and the driveshaft.

10. A frame comprising:
at least one flap configured to be moved between an open position and a closed position; and
a control device for controlling said at least one flap, the control device comprising,
at least one member made of shape memory material configured to be supplied with electric power so as to deform between a first state and a second state in order to disconnect said at least one flap from the actuator if the actuator fails; and
a track holder having at least two conductive tracks for supplying said at least one member made of shape memory material with electric power,
wherein said at least one member made of shape memory material has at least two contactor elements configured to each be arranged in electrical contact with an associated conductive track at least when said at least one member made of shape memory material is in the first state,
wherein the track holder is mounted on the frame in a rotationally retained manner.
